(19) United States
(12) Patent Application Publication
(10) Pub. No.: US 2005/0105688 A1
(43) Pub. Date: May 19, 2005

(54) X-ray apparatus with a component controllable from the x-ray detector

(76) Inventor: Martin Spahn, Erlangen (DE)

Correspondence Address: SCHIFF HARDIN, LLP;PATENT DEPARTMENT, 6600 SEARS TOWER, CHICAGO, IL, 60606-6473, US

(21) Appl. No.: 10/950,015

(22) Filed: Sep. 24, 2004

(30) Foreign Application Priority Data
Sep. 24, 2003 (DE) 103 44 365.7

(51) Int. Cl. G01N 23/04; H05G 1/64

(52) U.S. Cl. 378/98.8

(57) ABSTRACT

An x-ray apparatus has an x-ray source and a radiation detector, the radiation detector having a housing with a detector plate disposed at front side thereof, electronics contained in the housing for processing electrical signals generated by the detector plate dependent on incident radiation to produce image signals, and a flat screen, supplied with said image signals, disposed at a rear side of the housing for displaying the x-ray image. The flat screen includes a touch panel, and the x-ray apparatus further includes a controllable component, in communication with the radiation detector, controllable by entries made via the touch panel of the radiation detector.

### BACKGROUND OF THE INVENTION

1. Field of the Invention

The present invention concerns an x-ray apparatus of the type having a radiation detector having a flat screen display at which an x-ray image, acquired by a detector plate of the radiation detector, can be presented.

2. Description of the Prior Art

An x-ray detector is known from U.S. patent application Publication No. 2002/0150214. In this known x-ray detector, the acquired image data are transmitted to a control device via a wireless communication connection. An acquired image can be judged as its quality by a radiator by means of a monitor provided at the control device. Acquired x-ray images can also be transmitted to an x-ray image archiving system. The need for a specific control device for representation of an acquired x-ray image as well as to control the functions of the x-ray apparatus results in a relatively high space requirement. Aside from this, the production of the known control device is expensive and time-consuming.

From U.S. Pat. No. 6,590,958 discloses an x-ray apparatus having an x-ray radiator and an x-ray detector in which a detector plate is accommodated in a housing in the area of a front side of the housing, and a screen to show an acquired x-ray image is provided at a backside of the housing opposite the front side. Electronics accommodated on at least one circuit board are arranged between the detector plate and the flat screen.

U.S. patent application Publication No. 2003/0142788 discloses a portable medical x-ray diagnostic apparatus with a digital image sensor, a flat screen for displaying the acquired x-ray image as well as a touch screen for controlling the display.

### SUMMARY OF THE INVENTION

An object of the invention to provide an x-ray apparatus that avoids the disadvantages according to the prior art. In particular, an x-ray detector should be specified that enables provision of a simplified and space-saving x-ray apparatus.

This object is achieved in accordance with the invention by an x-ray apparatus having a radiation detector with a radiation detector plate at a front side of the detector housing and a flat screen provided on a backside of the detector housing opposite the front side of the detector. The flat screen enables the display of an acquired x-ray image. The quality of an acquired x-ray image can be immediately monitored by means of the flat screen provided on the x-ray detector without the need for a separate control device. Additionally, other items can be displayed on the flat screen that provide information about the parameters used to produce the x-ray image or to enable control of the x-ray apparatus from the detector itself

Electronics, accommodated on at least one circuit board are disposed between the detector plate and the flat screen. The electronics can be readout electronics for the readout of detector elements, electronics for the digitization of read-out measurement values, for image processing, for wireless transmission of data, as well as for control of the x-ray apparatus. The electronics can be fashioned to perform all functions of a control device according to the prior art.

For this purpose, the flat screen embodies a device for initiation of functions by means of contact. The flat screen thus is a type of sensor screen or “touch panel” as is known in the art. This advantageously enables control and/or adjustment of the x-ray apparatus directly from the radiation detector without uses of a mouse or a keyboard.

The electronics can include a device for wireless transmission and reception of data. The control and regulation device embodied in the radiation detector thus can be used without cables connected thereto and the detector or plate can be a mobile according to a type of x-ray storage plate. According to a further embodiment, the electronics include a device for image processing. By means of such a device, it is in particular possible to correct image artifacts or to post-process the image according to user specifications.

The flat screen can be an LCD (Liquid Crystal Display) or an OLED (Organic Light Emitting Device) screen. Such screens are available relatively inexpensively. X-ray images can therewith be shown at a resolution sufficient to assess the quality of the x-ray image.

According to a further embodiment, a power source, preferably an accumulator, is contained in the housing. This measure likewise contributes to a wireless execution of the x-ray detector. Furthermore, an interface for hardwired transmission of data can be provided on the housing. This can be a conventional interface, for example a USB interface or the like. By means of such an interface, for example, updated versions of computer programs can be transmitted to the electronics in a simple manner.

The detector plate can be formed of a number of detector elements arranged in the X— and Y-directions (columns and rows). The detector elements form a detector matrix. The detector elements can be produced from amorphous silicon, and can be accommodated on a glass or plastic substrate. The detector elements, for example, can be photodiodes or elements for charge measurement (CCD elements). The execution of the detector elements from amorphous silicon enables miniaturized manufacturing in a relatively simple manner. In addition, the matrix can include CMOS chips that enable a further degree of integration. For example, intensifiers, ADCs (analog to digital converters) or other electronic circuits can be directly integrated in the large-area CMOS structure.

According to a further embodiment, the detector elements are superimposed by a converter layer preferably produced from a luminophore. The luminophore can be a scintillator, for example Csl or the like. In the scintillator, absorbed x-ray quanta are converted into light. The light can be acquired with the detector elements fashioned in the form of photodiodes. This represents a converter layer with indirect conversion. Alternatively, the converter layer can be formed of amorphous silicon. In this case, absorbed x-ray quanta are transduced into charges in such a converter layer. The charges can be acquired with detector elements fashioned in the form of charge detectors. This case represents a directly converting converter layer.

The x-ray apparatus includes an x-ray radiator fed by a high voltage generator a device for transmission and reception of data and the aforementioned x-ray detector. Such an x-ray apparatus is controlled directly from the x-ray detector, such as by controlling or adjusting the high-voltage generator.

### DESCRIPTION OF THE DRAWINGS

FIG. 1 is a perspective, partially broken-away view of a detector plate according to the prior art, suitable for use in accordance with the invention.

FIG. 2 is a schematic section view of an x-ray detector in accordance with the invention.

FIG. 3 is a schematic illustration of a first x-ray apparatus in accordance with the invention.

FIG. 4 is a schematic illustration of a second embodiment of an x-ray apparatus in accordance with the invention.

### DESCRIPTION OF THE PREFERRED EMBODIMENTS

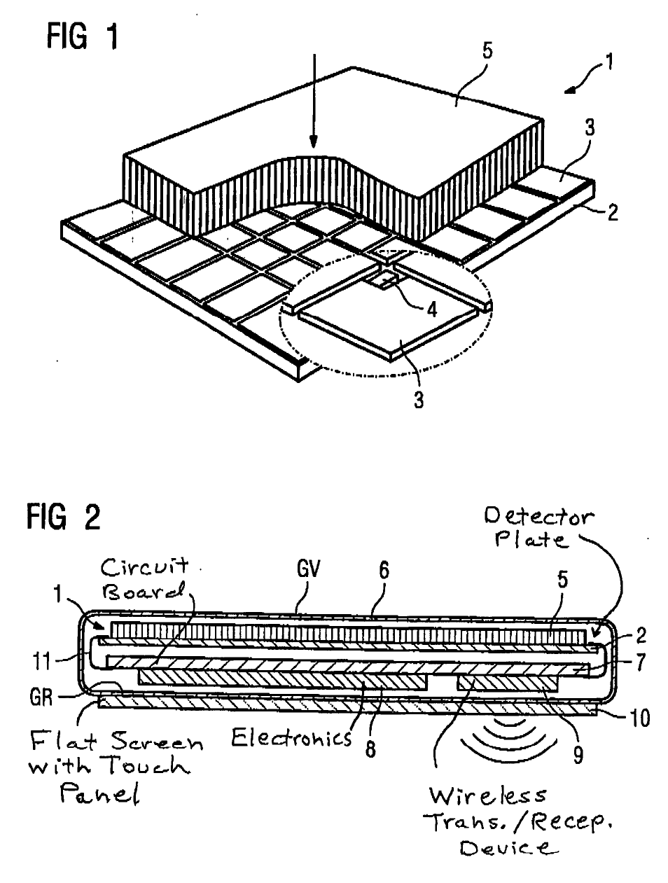

In the detector plate 1 shown in FIG. 1, a number of detector elements 3 are accommodated on a substrate 2 produced, for example, from glass. The detector elements 3 are disposed in regular arrangement in the X— and Y-directions, and form a detector matrix. The detector elements 3 can be photodiodes produced from amorphous silicon. Each of the detector elements 3 can include a switch 4. A converter layer 5 produced, for example, from a luminophore is applied on the detector elements 3. The luminophore, for example, can be Csl. Instead of the previously specified detector elements with a converter layer, large-area CMOS chips, CCDs (Charged Couple Device) or APS (Active Pixel Sensor) can be used.

In the x-ray detector shown in FIG. 2, the detector plate 1 is contained in a housing 6. The converter layer 5 faces a front side GV of the housing 6. The detector plate 1 is mounted in the area of the front side GV. A circuit board 7 with electronics 8 thereon is disposed between the detector plate 1 and a backside GR of the housing 6. The electronics 8 are in principle a microcomputer. The functions of the microcomputer can be controlled by suitable programs selected by entries made via a flat screen 10 executed as a touch panel. The electronics 8 can operate according to programs for sequential readout of the detector elements 3, for digitization of the read-out measurement values, correction, image processing, for wireless transmission and reception of data, and the like. A wireless transmission/reception device 9 for transmission or reception of data is likewise provided on the circuit board 7. The flat screen 10 is mounted on the housing backside GR. The flat screen 10 alternatively can be integrated into the housing backside GR. The flat screen 10 is, for example, an LCD or OLED screen. The electronics 8 are connected with the detector elements via lines 11. Instead of the lines 11, bonding connections, plug connections or feedthroughs can also be used for contacting. An accumulator (not shown) also can be contained in the housing 6. The electronics 8 can be connected to an interface (not shown) likewise provided on the housing 6.

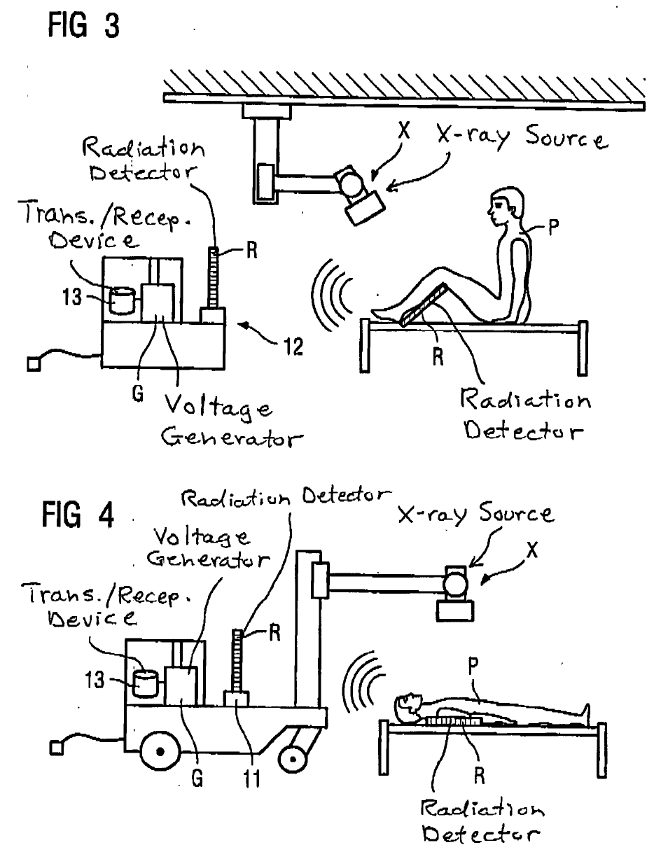

FIG. 3 shows a first embodiment of an inventive x-ray apparatus. The x-ray detector shown in FIG. 2 is designated with the reference character R and an x-ray radiator is designated with the reference character X. A generator G for generation of the high voltage necessary for operating the x-ray radiator X can be provided with a charging station 12 for acceptance of the x-ray detector R. Upon placement or connection of the x-ray detector with the charging station 12, connection of a data line (not shown) provided on the charging station 12 with the aforementioned interface can also be established; an automatic readout of image data stored in the electronics 8 can ensue. The unit housing the generator G can also has a further transmission/reception device 13 to receive and send data.

FIG. 4 shows a second embodiment of an inventive x-ray apparatus. The x-ray radiator X, the generator G, the charging station 12 and the further transmission and reception device are thereby combined into a mobile unit.

The function of the x-ray detector as well as of the x-ray apparatus is as follows:

X-ray radiation emitted by the x-ray radiator X penetrates a subject, for example a patient P shown in FIGS. 3 and 4. The absorption pattern of the x-ray radiation is imaged on the detector plate 1. The values measured by the detector elements 3 are read out, digitized, intensified and transduced into image information line-by-line for each of the detector elements 3 by of the electronics 8. A digital image produced by of the electronics 9 can immediately be shown on the flat screen 10.

The flat screen 10 is fashioned as a “touch panel”, meaning specific functions can be triggered by contact of function areas displayed on the screen. Thus, for example, the x-ray image displayed on the flat screen 10 can be transmitted to the further transmission/reception device 13 by means of the transmission/reception device 9. The transmitted data can be stored at another location and can be retrieved as needed from this other location and be used for representation of the x-ray image.

By means of the touch panel of the radiation detector R it is also possible to configure (control) the x-ray apparatus. For example, parameters can be set or changed at the touch panel by the operator. Thus, for example, an organ protocol suitable for the x-ray exposure to be produced can be selected from among a number of organ protocols. An image processing can also ensue by means of the electronics 8 using the touch panel. An image displayed on the flat screen 10, for example, can undergo specific predetermined filterings or corrections.

In addition to configuration of the x-ray apparatus, it is also possible to display on the flat screen 10 a task list to be executed on the patient to be examined. The task list can be created by means of an HIS (Hospital Information System) and/or using an RIS system (Radiology Information System). The task list contains person-specific data, and also can contain data about the x-ray examination to be implemented on the respective person. Since the flat screen 10 is fashioned as a touch panel, the image data displayed thereon can be transmitted to a PACS (Picture Archival and Communication System).

Although modifications and changes may be suggested by those skilled in the art, it is the intention of the inventor to embody within the patent warranted hereon all changes and modifications as reasonably and properly come within the scope of his contribution to the art.

1. An X-ray apparatus comprising:
an x-ray source that emits x-rays;
a radiation detector comprising a housing having a front side and a backside, a detector plate disposed at said front side of said housing for detecting said x-rays and generating electrical signals corresponding thereto, electronics for processing said electrical signals to generate output signals representing an x-ray image, and a flat screen supplied with said output signals and disposed at said backside of said housing for displaying said x-ray image, said flat screen comprising a touch panel;
a controllable component, remote from said radiation detector, operable by an entry made via said touch panel to set at least one parameter associated with generation of said x-ray image; and
a communication link between said radiation detector and said controllable component for forwarding entries made via said touch pad to said controllable component.

2. An x-ray apparatus as claimed in claim 1 wherein said electronics comprise a circuit board disposed between said detector plate and said flat screen in said housing.

3. An x-ray apparatus as claimed in claim 1 wherein said transmission link is a wireless transmission link comprising a wireless transmitter in said radiation detector and a wireless receiver at said controllable component.

4. An x-ray apparatus as claimed in claim 1 wherein said electronics comprise an image processor.

5. An x-ray apparatus as claimed in claim 1 wherein said flat screen is selected from the group consisting of an LCD screen and an OLED screen.

6. An x-ray apparatus as claimed in claim 1 comprising a power source for supplying power to said electronics and to said flat screen contained in said housing.

7. An x-ray apparatus as claimed in claim 6 wherein said power source is an accumulator,

8. An x-ray apparatus as claimed in claim 1 comprising an exteriorly accessible interface disposed at said housing and connected to said electronics for hardwired transmission of data to said electronics.

9. An x-ray apparatus as claimed in claim 1 wherein said detector plate comprises a plurality of detector elements respectively disposed in columns and rows.

10. An x-ray apparatus as claimed in claim 9 wherein said detector elements are comprised of amorphous silicon.

11. An x-ray apparatus as claimed in claim 9 wherein said detector plate comprises a substrate on which said detector elements are disposed

12. An x-ray apparatus as claimed in claim 11 wherein said substrate is comprised of a material selected from the group consisting of glass and plastic.

13. An x-ray apparatus as claimed in claim 9 wherein said detector plate comprises a converter layer superimposed on said detector elements.

14. An x-ray apparatus as claimed in claim 13 wherein said converter layer is comprised of a luminophore.

15. An x-ray apparatus as claimed in claim 1 wherein said controllable component is a high voltage generator connected to said x-ray source for feeding said x-ray source.
